(19) United States
(12) Patent Application Publication
(10) Pub. No.: US 2025/0008385 A1
(43) Pub. Date: Jan. 2, 2025

(54) SYSTEMS AND METHODS FOR INTER-DONOR MIGRATION AND APPARATUS

(71) Applicant: ZTE Corporation, Shenzhen (CN)

(72) Inventors: Ying HUANG, Shenzhen (CN); Lin CHEN, Shenzhen (CN)

(73) Assignee: ZTE Corporation, Shenzhen (CN)

(21) Appl. No.: 18/883,142

(22) Filed: Sep. 12, 2024

Related U.S. Application Data
(63) Continuation of application No. PCT/CN2022/097413, filed on Jun. 7, 2022.

(51) Int. Cl. H04W 36/00; H04W 24/02; H04W 76/12; H04W 88/08

(52) U.S. Cl. CPC H04W 36/0061; H04W 24/02; H04W 76/12; H04W 88/08

(57) ABSTRACT

Presented are systems, methods, apparatuses, or computer-readable media for inter-donor migration and apparatus. A first network node may receive information related to handover of a wireless communication device from a second network node. The first network node can send configuration update information to a third network node.

### CROSS-REFERENCE TO RELATED APPLICATION

This application claims the benefit of priority under 35 U.S.C. § 120 as a continuation of International Patent Application No. PCT/CN2022/097413, filed on Jun. 7, 2022, the disclosure of which is incorporated herein by reference in its entirety.

### TECHNICAL FIELD

The disclosure relates generally to wireless communications, including but not limited to systems and methods for inter-donor migration and apparatus.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, a method, an apparatus, or a computer-readable medium for migrating integrated access and backhaul (IAB) nodes. A first network node can receive/obtain/collect/acquire information related to handover/migration/switching (e.g., operations/procedures of handover) of a wireless communication device (e.g., UE) from a second network node. The first network node can send/transmit/provide/communicate configuration update information to a third network node.

In some implementations, the third network node can comprise an integrated access and backhaul (IAB) node. In some cases, the first network node can comprise (e.g., correspond to, be associated with, be a part of, or have) a target IAB donor, and the second network node can comprise a source IAB donor. In some other cases, the first network node can comprise the source IAB donor, and the second network node can comprise the target IAB donor.

In some implementations, the information related to the handover can comprise at least one of: an IP address of the second network node for control plane or user plane, an IP address of the third network node for control plane or user plane, a gNB centralized unit (gNB-CU) user equipment (UE) F1 application protocol (F1AP) identifier (ID) allocated by the second network node, a gNB distributed unit (gNB-DU) UE F1AP ID allocated by the third network node, a general packet radio service (GPRS) tunneling protocol (GTP) tunnel endpoint identifier (TEID) allocated by the second network node, a GTP TEID allocated by the third network node, an identity of the second network node, an identity of the third network node, an identity of the wireless communication device, an indication of migration type, and/or backhaul (BH) information.

In some implementations, the first network node can receive the information related to the handover from the second network node, via a user equipment (UE) associated message or a non-UE associated message. In some implementations, the first network node can send response information to the second network node. The response information can comprise at least one of: a differentiated service code point (DSCP), an IPV6 flow label, and/or a backhaul adaptation protocol (BAP) control protocol data unit (PDU) radio link control (RLC) channel (CH) list.

In some implementations, the configuration update information can comprise at least one of: an IP address of the first network node for control plane or user plane, an IP address of the second network node for control plane or user plane, an IP address of the third network node for control plane or user plane, a gNB centralized unit (gNB-CU) user equipment (UE) F1 application protocol (F1AP) identifier (ID) allocated by the first network node, a gNB-CU UE F1AP ID allocated by the second network node, a gNB distributed unit (gNB-DU) UE F1AP ID allocated by the third network node, a general packet radio service (GPRS) tunneling protocol (GTP) tunnel endpoint identifier (TEID) allocated by the first network node, a GTP TEID allocated by the second network node, a GTP TEID allocated by the third network node, an identity of the first network node, an identity of the second network node, an identity of the wireless communication device, an indication of migration type, and/or backhaul (BH) information.

In some implementations, the indication of migration type can comprise: partial migration, full migration, distributed unit (DU) migration, migration of the wireless communication device (e.g., UE migration), F1 transport migration, F1 switch indication, a source logical DU indication, a target logical DU indication, or a new integrated access and backhaul (IAB) donor indication. In some implementations, the BH information can comprise at least one of: a backhaul adaptation protocol (BAP) routing ID, a next hop BAP address, and/or an egress BH radio link control (RLC) channel (CH) ID. In some implementations, the first network node can send the configuration update information to the third network node via a user equipment (UE) associated message or a non-UE associated message.

In some implementations, the first network node can receive a response message from the third network node. The response message can comprise at least one of: an IP address of the first network node for control plane or user plane, an IP address of the second network node for control plane or user plane, an IP address of the third network node for control plane or user plane, a new IP address of the third network node for control plane or user plane, a gNB centralized unit (gNB-CU) user equipment (UE) F1 application protocol (F1AP) identifier (ID) allocated by the first network node, a gNB-CU UE F1AP ID allocated by the second network node, a gNB distributed unit (gNB-DU) UE F1AP ID allocated by the third network node, a new gNB-DU UE F1AP ID allocated by the third network node, a general packet radio service (GPRS) tunneling protocol (GTP) tunnel endpoint identifier (TEID) allocated by the first network node, a GTP TEID allocated by the second network node, a GTP TEID allocated by the third network node, a new GTP TEID allocated by the third network node, and/or an identity of the wireless communication device. In some implementations, the first network node can receive the response message from the third network node via a user equipment (UE) associated message or a non-UE associated message.

In some implementations, the first network node can send/transmit/provide second configuration update information to the second network node. The second configuration update information can comprise at least one of: an IP address of the first network node for control plane or user plane, an IP address of the second network node for control plane or user plane, an IP address of the third network node for control plane or user plane, a new IP address of the third network node for control plane or user plane, a gNB centralized unit (gNB-CU) user equipment (UE) F1 application protocol (F1AP) identifier (ID) allocated by the first network node, a gNB-CU UE F1AP ID allocated by the second network node, a gNB distributed unit (gNB-DU) UE F1AP ID allocated by the third network node, a new gNB-DU UE F1AP ID allocated by the third network node, a general packet radio service (GPRS) tunneling protocol (GTP) tunnel endpoint identifier (TEID) allocated by the first network node, a GTP TEID allocated by the second network node, a GTP TEID allocated by the third network node, a new GTP TEID allocated by the third network node, an identity of the third network node, or an identity of the wireless communication device.

At least one aspect is directed to a system, a method, an apparatus, or a computer-readable medium for migrating integrated access and backhaul (IAB) nodes. A second network node can send/transmit/provide information related to handover of a wireless communication device (e.g., UE) to a first network node. The first network node can send configuration update information to a third network node.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates a block diagram of an environment for a mobile integrated access and backhaul (IAB), in accordance with an illustrative embodiment;

FIG. 4A illustrates a block diagram of an integrated access and backhaul (IAB) architecture using standalone (SA) mode with a next generation core (NGC), in accordance with an illustrative embodiment;

FIG. 4B illustrates a block diagram of an integrated access and backhaul (IAB) architecture using Evolved Universal Mobile Telecommunications System New Radio (EN-DC), in accordance with an illustrative embodiment;

FIG. 5 illustrates a block diagram of integrated access and backhaul (IAB) nodes in a parent and child relationship, in accordance with an illustrative embodiment;

FIG. 6A illustrates a block diagram of an integrated access and backhaul (IAB) mobile termination (MT) migrating from a first donor distributed unit (DU1) of a first centralized unit (CU1) to a second donor distributed unit (DU2) of a second donor centralized unit (CU2), in accordance with an illustrative embodiment;

FIG. 6B illustrates a block diagram of an integrated access and backhaul (IAB) mobile termination (MT) migrating from a second donor distributed unit (DU2) of a second donor centralized unit (CU2) to a third donor distributed unit (DU3) of a third donor centralized unite (CU3), in accordance with an illustrative embodiment;

FIG. 6C illustrates a block diagram of an integrated access and backhaul (IAB) distributed unit (DU) migrating from a first donor centralized unit (CU1) to a third donor centralized unit (CU3), in accordance with an illustrative embodiment; and

FIG. 7 illustrates of a flow diagram of a method for inter-donor migration and apparatus, in accordance with an illustrative embodiment.

### DETAILED DESCRIPTION

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 1. Mobile Communication Technology and Environment

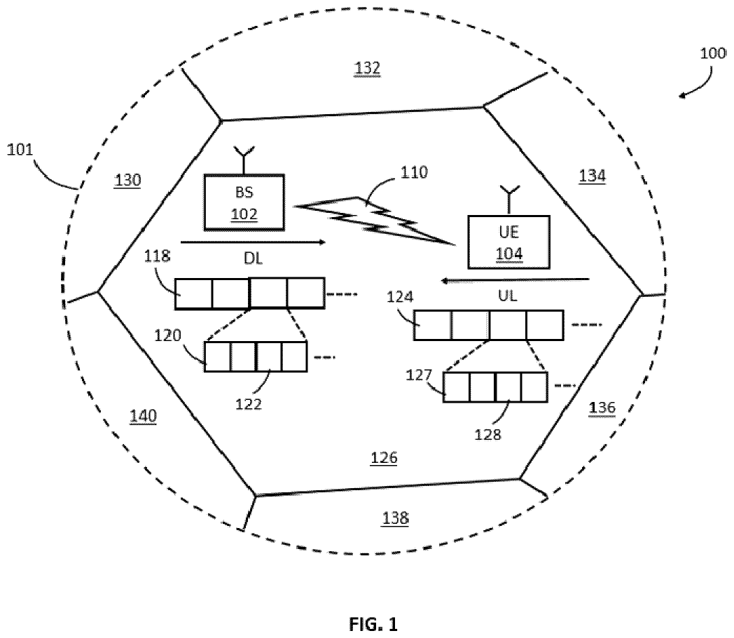

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

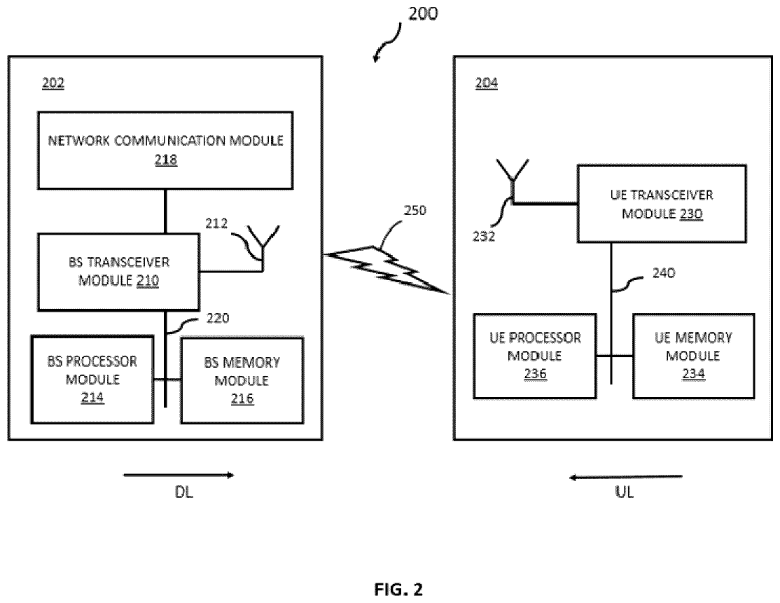

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

### 2. Systems and Methods for Inter-Donor Migration and Apparatus

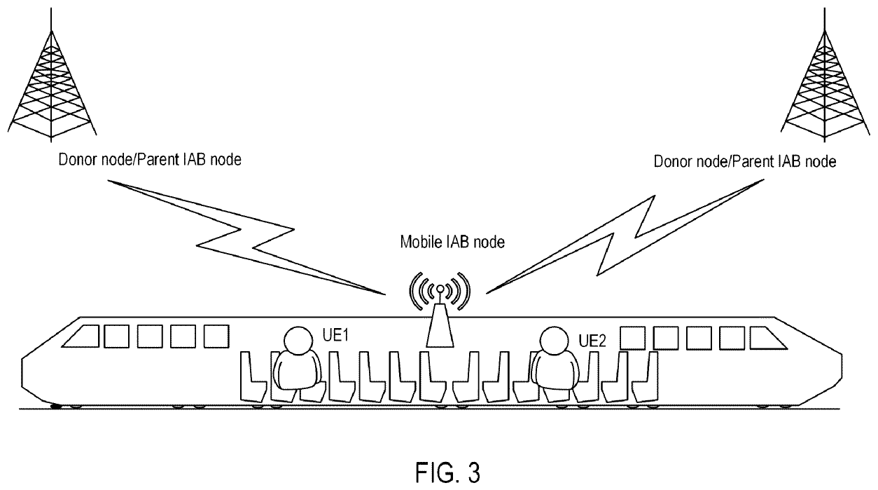

Referring now to FIG. 3, depicted is a block diagram of an environment for a mobile integrated access and backhaul (IAB). An Integrated Access and Backhaul (IAB) may support wireless backhauling via new radio (NR) enabling flexible and very dense deployment of NR cells while reducing the need for wireline transport infrastructure. Intra-donor centralized unit (CU) migration procedure may be provided in which both the source and the target parent node are served by the same IAB-donor-CU. The inter-donor CU migration in the migrating (mobile) IAB node, however, may be static. It may be difficult to perform inter-donor migration in a mobile IAB use scenario as depicted. In a mobile IAB use case, IAB nodes are mounted in vehicles and can provide coverage and capacity enhancement to onboard or surrounding user equipment (UEs).

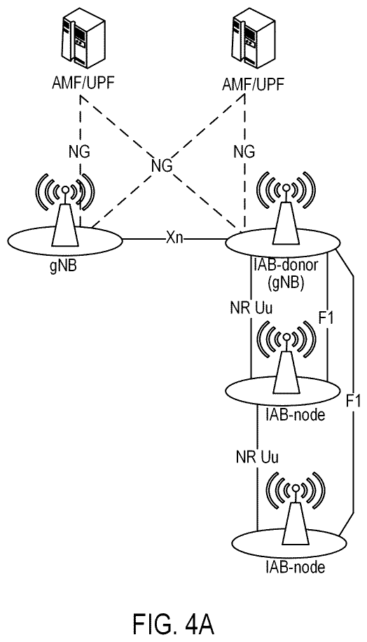

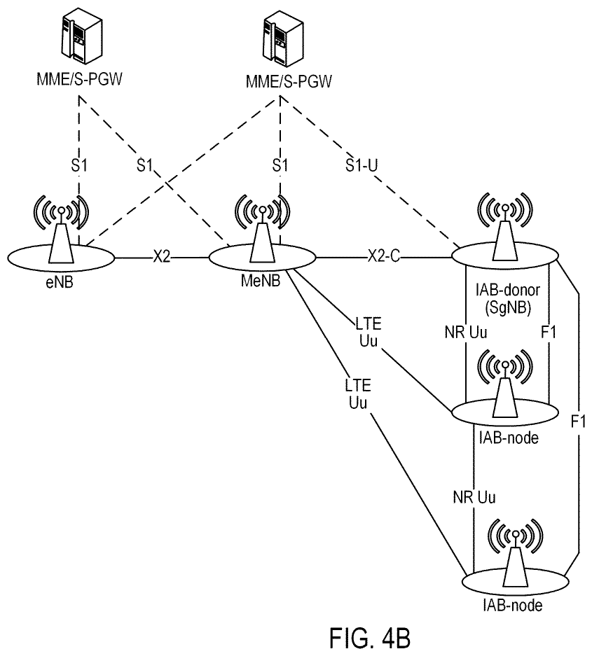

Referring now to FIG. 4A, depicted is a block diagram of an integrated access and backhaul (IAB) architecture using standalone (SA) mode with a next generation core (NGC). The integrated access and backhaul (IAB) can enable wireless relaying in NG-RAN. The relaying node, referred to as IAB node, may support access and backhauling via NR. The terminating node of NR backhauling on network side may be referred to as the IAB-donor, which can represent a gNB with additional functionality to support IAB. Backhauling can occur via a single or via multiple hops.

The IAB node may support gNB-DU functionality, to terminate the NR access interface to UEs and next-hop IAB nodes, and/or to terminate the F1 protocol to the gNB-CU functionality, on the IAB-donor. The gNB-DU functionality on the IAB node may be also referred to as IAB distributed unit (DU) (IAB-DU). In addition to the gNB-DU functionality, the IAB node may also support a subset of the UE functionality referred to as IAB-mobile termination (MT), which can include, e.g., physical layer, layer-2, radio resource control (RRC) and non-access stratum (NAS) functionality to connect to the gNB-DU of another IAB node or the IAB-donor, to connect to the gNB-CU on the IAB-donor, and to the core network, among others.

Referring now to FIG. 4B, depicted is a block diagram of an integrated access and backhaul (IAB) architecture using Evolved Universal Mobile Telecommunications System New Radio (EN-DC). The IAB node can access the network using either SA-mode or EN-DC. In EN-DC, the IAB node also connects via E-UTRA to a MeNB, and the IAB-donor terminates X2-C as SgNB (e.g., as defined in TS 37.340).

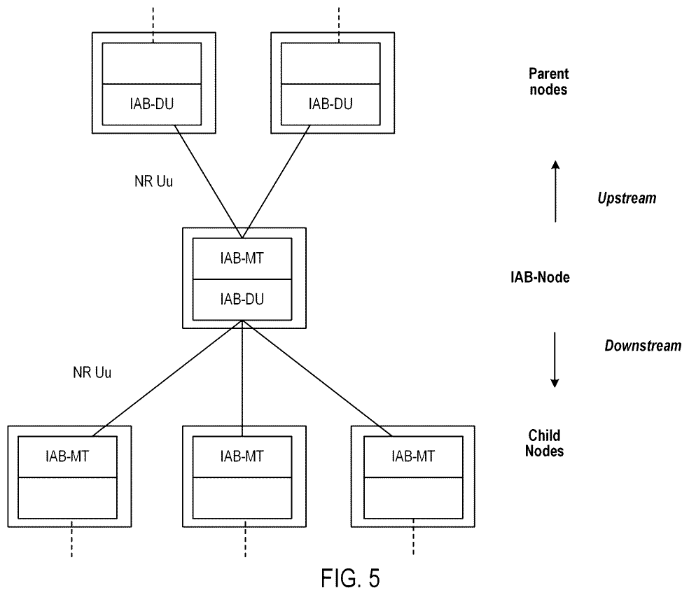

Referring now to FIG. 5, depicted is a block diagram of integrated access and backhaul (IAB) nodes in a parent and child relationship. All IAB nodes that are connected to an IAB-donor via one or multiple hops can form a directed acyclic graph (DAG) topology with the IAB-donor at its root. In this DAG topology, the neighbor node on the IAB-DU's interface may be referred to as child node and the neighbor node on the IAB-MT's interface is referred to as parent node. The direction toward the child node may be further referred to as downstream while the direction toward the parent node is referred to as upstream. The IAB-donor may perform centralized resource, topology and route management for the IAB topology.

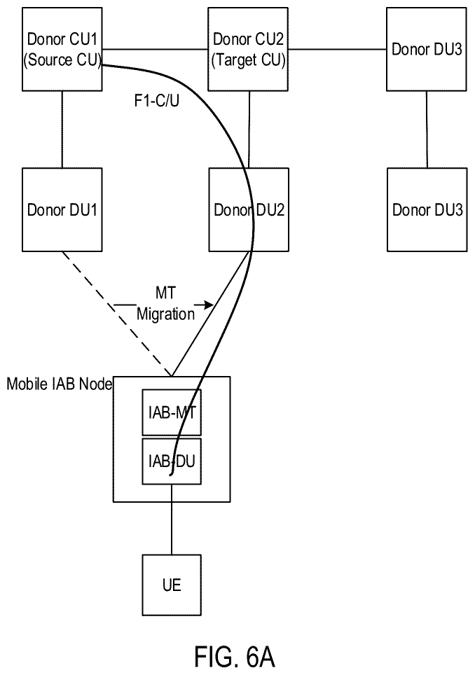

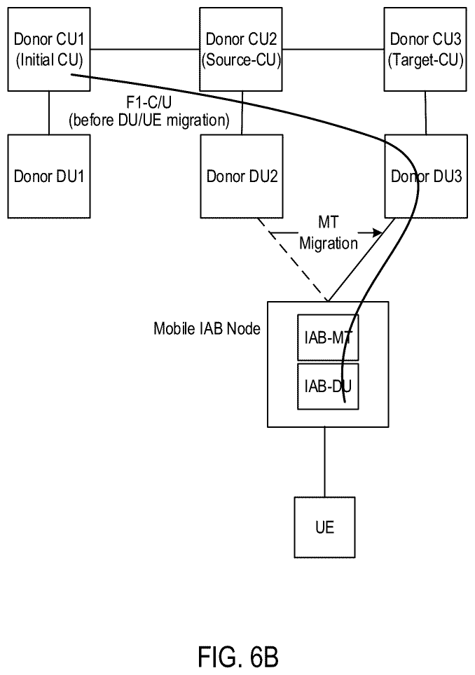

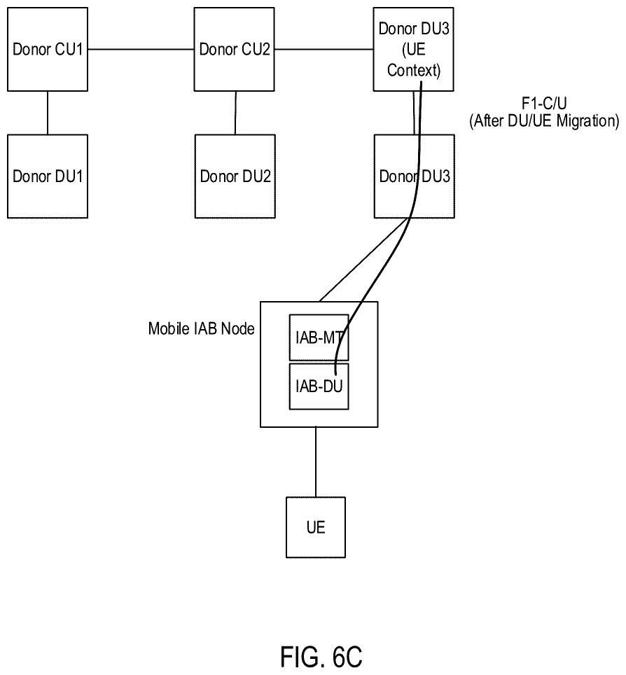

Referring to FIG. 6A, depicted is a block diagram of an integrated access and backhaul (IAB) mobile termination (MT) migrating from a first donor distributed unit (DU1) of a first centralized unit (CU1) to a second donor distributed unit (DU2) of a second donor centralized unit (CU2) (e.g., MT migration). As depicted, the mobile IAB-MT may migrate from donor DU1 (which belongs to donor CU1) to donor DU2 (which belongs to donor CU2). The mobile IAB-DU, however, may maintain its F1 connection with donor CU1, and UE context can remain in/with the donor CU1. F1-C/U traffic between donor CU1 and mobile IAB-DU may be transmitted via donor DU2.

Referring to FIG. 6B, depicted is a block diagram of an integrated access and backhaul (IAB) mobile termination (MT) migrating from a second donor distributed unit (DU2) of a second donor centralized unit (CU2) to a third donor distributed unit (DU3) of a third donor centralized unite (CU3). As depicted, mobile IAB-MT may migrate from donor DU2 (which belongs to donor CU2) to donor DU3 (which belongs to donor CU3). The mobile IAB-DU, however, may maintain its F1 connection with donor CU1, and UE context can remain in/with donor CU1. F1-C/U traffic between donor CU1 and mobile IAB-DU may be transmitted via donor DU3.

Referring to FIG. 6C, depicted is a block diagram of an integrated access and backhaul (IAB) distributed unit (DU) migrating from a first donor centralized unit (CU1) to a third donor centralized unit (CU3). As depicted, the mobile IAB-DU may migrate from donor CU1 to donor CU3. The UE may be handed over (or undergo handover/migration/switching) from donor CU1 to donor CU3. F1-C/U traffic between donor CU3 and mobile IAB-DU may be transmitted via donor DU3.

As depicted in FIGS. 6A-C, the respective donor CU can be associated with or correspond to at least one of a source IAB donor, target IAB donor, or an initial IAB donor. For example, the source IAB donor can represent a donor including a donor DU previously connected to or in communication with the mobile IAB-MT or the UE 104. The target IAB donor can represent a donor CU that the mobile IAB-MT or the UE migrated to. The initial IAB donor can represent the at least one IAB donor having F1-C connection with the mobile IAB-node, or one IAB donor which is the source IAB donor of the UE, or one IAB donor which is serving the UE 104 (e.g., gNB, BS 102, or donor CU serving the UE 104). Hereinafter, the mobile IAB node and/or mobile IAB-DU may sometimes be referred to generally as IAB node and/or IAB-DU, respectively.

### 1. Implementation 1 for UE Migration Procedure Triggered by MT Migration Procedure

In certain deployment or environments of network communication, the migration or handover of the UE 104 (e.g., operations/procedures on/for UE migration/handover/switching) may require to be performed after or subsequent to IAB-MT migration (e.g., operations/procedures on/for MT migration/handover/switching). During the UE handover/migration procedure, the CU (e.g., IAB-donor CU (sometimes referred to generally as donor CU), gNB, or BS 102) serving the one or more UEs 104 may be changed/switched/transferred/exchanged/handover (e.g., with/to another IAB-donor), while the DU (e.g., IAB-donor DU (sometimes referred to generally as donor DU)) serving the UE 104 can remain, be maintained, or be kept unchanged (e.g., the donor DU continues to serve or remains in connection with the UE 104). However, conventional systems may not support the UE handover/migration operation/procedure due to, in response to, according to, based on, or triggered by an MT migration (e.g., operation/procedure for enabling MT migration followed by UE migration). The systems, methods, apparatuses, and/or computer-readable media discussed herein can provide operations/procedures for UE handover/migration/switching due to MT migration.

In various implementations, during the UE handover/migration, the UE-associated logical F1-connection and/or F1-U tunnel (e.g., sometimes referred to as F1-C/U) may be switched/migrated/transferred from the source CU (e.g., source IAB-donor or source donor) of the UE 104 (e.g., source CU associated with the UE 104) to the target CU (e.g., target IAB-donor or target donor) of the UE 104 (e.g., target CU associated with the UE 104). For example, as a first step, the source CU (e.g., of a first network node) of the UE 104 can transmit/send/provide UE handover preparation information (e.g., information related to handover/migration of the UE 104) to the target CU (e.g., of a second network node) of the UE 104. The UE handover preparation information can include at least one of the following:
1) IP address of the source CU (e.g., of the first network node) for the control plane (e.g., carrying signaling traffic) and/or user plane (e.g., carrying user data);
2) IP address of the IAB-DU (e.g., of a third network node or the IAB node) for the control plane or user plane;
3) gNB centralized unit (gNB-CU) (e.g., IAB-donor-CU) user equipment (UE) F1 application protocol (F1AP) identifier (ID) allocated by the source CU, which may correspond to the UE identity used in F1 interface allocated by the source CU;
4) gNB-DU UE F1AP ID allocated by the IAB-DU (e.g., CU UE F1AP ID and DU UE F1AP ID may be used to identify one F1 association), which may correspond to the UE identity used in F1 interface allocated by the IAB-DU;
5) General packet radio service (GPRS) tunneling protocol (GTP) tunnel endpoint identifier (TEID) allocated by the source CU, which may correspond to the GTP tunnel identity used in F1 interface allocated by the source CU;
6) GTP TEID allocated by the IAB-DU, which may correspond to the GTP tunnel identity used in F1 interface allocated by the IAB-DU;
7) Identity of the source CU;
8) Identity of the IAB-DU (e.g., BAP address, which can be allocated for each logical DU by the donor CU to the IAB node);
9) Identity of the UE; and/or
10) An indication of migration type, which can include at least one of the following: partial migration, full migration, DU migration, UE migration, F1 transport migration, and/or F1 switch indication. Partial migration can include the migration/handover/switching of an IAB-MT to a parent node underneath or associated with a different IAB-donor-CU while the collocated IAB-DU and/or descendant IAB-node(s) (e.g., if any) can terminate at the initial IAB-donor-CU. Full migration can include the migration of the boundary IAB node and/or the descendant IAB node(s) (e.g., both RRC and F1 connection) to a second IAB donor CU from a first IAB donor CU. DU migration can include the migration of IAB-DU from one IAB donor to another IAB donor. UE migration can include the migration of the UE 104 from one radio access network (RAN) node to another RAN node. F1 transport migration can include the migration of the transport path of F1 traffic from one path to another path.

The source CU may send the UE handover preparation information to the target CU via UE associated message (e.g., message specific to, assigned to, or designated for a certain UE 104) and/or non-UE associated XnAP message (e.g., message not specific to a particular UE 104 or message for one or more UEs 104). As a second step, additionally or optionally, the target CU (e.g., of the second network node) can send/transmit/provide response information (e.g., response message or signaling) to the source CU (e.g., of the first network node). The response information can include at least one of: differentiated service code point (DSCP), an IPv6 flow label, and/or a backhaul adaptation protocol (BAP) control protocol data unit (PDU) radio link control (RLC) channel (CH) list.

As a third step, the target CU may send the configuration update information to the IAB node (e.g., third network node). The configuration update information can include at least one of the following:
1) IP address of the source CU (e.g., of the first network node) for the control plane or user plane;
2) IP address of the target CU (e.g., of the second network node) for the control plane or user plane;
3) IP address of the IAB-DU (e.g., of the third network node or IAB node) for the control plane or user plane;
4) gNB-CU UE F1AP ID allocated by the source CU;
5) gNB-CU UE F1AP ID allocated by the target CU;
6) gNB-DU UE F1AP ID allocated by the IAB-DU;
7) GTP TEID allocated by the source CU;
8) GTP TEID allocated by the target CU;
9) GTP TEID allocated by the IAB-DU;
10) Identity of the source CU (e.g., sometimes referred to as source CU ID);
11) Identity of the UE (e.g., sometimes referred to as UE ID);
12) BH information, which can include at least one of: BAP routing ID, next hop BAP address, and/or egress BH RLC CH ID; and/or
13) An indication of migration type, which can include at least one of: partial migration, full migration, DU migration, UE migration, F1 transport migration, F1 switch indication, source logical DU indication (e.g., BAP address), target logical DU indication (e.g., BAP address), and/or new IAB donor indication.

The target CU may send the configuration update information to the IAB node via UE associated message and/or non-UE associated F1AP message. As a fourth step, the IAB node (e.g., the third network node) may send/transmit/provide a response message or signal to the target CU. The IAB node can transmit the response message in response to, subsequent to, or after receiving the configuration update information from the target CU. The response message can include at least one of the following:
1) IP address of the source CU for the control plane or user plane;
2) IP address of the target CU for the control plane or user plane;
3) IP address (e.g., old/previous/existing IP address) of the IAB-DU for the control plane or user plane;
4) New IP address of the IAB-DU for the control plane or user plane;
5) gNB-CU UE F1AP ID allocated by the source CU;
6) gNB-CU UE F1AP ID allocated by the target CU;
7) gNB-DU UE F1AP ID (e.g., old/previous/existing gNB-DU UE F1AP ID) allocated by the IAB-DU;
8) New gNB-DU UE F1AP ID allocated by the IAB-DU;
9) GTP TEID allocated by the source CU;
10) GTP TEID allocated by the target CU;
11) GTP TEID (e.g., old/previous/existing GTP TEID) allocated by the IAB-DU; and/or
12) New GTP TEID allocated by the IAB-DU.

The IAB node (e.g., the third network node) may send the above information (e.g., information of the response message) to the target CU via UE associated message and/or non-UE associated F1AP message. Based on the configuration update information, the UE's F1 control plane and user plane can be migrated or handed over (or undergo handover/migration/switching) from one donor CU to another (e.g., initial CU to target CU and/or source CU to target CU).

### II. Implementation 2 for UE Migration Procedure Triggered by MT Migration Procedure

In certain deployment or environments of network communication, the migration or handover of the UE 104 (e.g., operations/procedures on/for UE migration/handover/switching) may require to be performed after or subsequent to IAB-MT migration (e.g., operations/procedures on/for MT migration/handover/switching). During the UE handover/migration procedure, the CU (e.g., IAB-donor CU (sometimes referred to generally as donor CU), gNB, or BS 102) serving the one or more UEs 104 may be changed/switched/transferred/exchanged/handover (e.g., with/to another IAB-donor), while the DU (e.g., IAB-donor DU (sometimes referred to generally as donor DU)) serving the UE 104 can remain, be maintained, or be kept unchanged (e.g., the donor DU continues to serve or remains in connection with the UE 104). However, conventional systems may not support the UE handover/migration operation/procedure due to, in response to, according to, based on, or triggered by an MT migration procedure. The systems, methods, apparatuses, and/or computer-readable media discussed herein can provide operations/procedures for UE handover/migration/switching due to MT migration.

In various implementations, during the UE handover/migration, the UE-associated logical F1-connection and/or F1-U tunnel (e.g., sometimes referred to as F1-C/U) may be switched/migrated/transferred from the source CU (e.g., source IAB-donor or source donor) to the target CU (e.g., target IAB-donor or target donor). As a first step, the target CU (e.g., of a first network node) may send UE handover-related information to the source CU (e.g., of a second network node). The UE handover-related information can include at least one of the following:
1) IP address of the target CU (e.g., of the first network node) for the control plane (e.g., carrying signaling traffic) and/or user plane (e.g., carrying user data);
2) IP address of the IAB-DU (e.g., of a third network node or the IAB node) for the control plane or user plane;
3) gNB centralized unit (gNB-CU) (e.g., IAB-donor-CU) user equipment (UE) F1 application protocol (F1AP) identifier (ID) allocated by the target CU;
4) gNB-DU UE F1AP ID allocated by the IAB-DU (e.g., CU UE F1AP ID and DU UE F1AP ID may be used to identify one F1 association);
5) General packet radio service (GPRS) tunneling protocol (GTP) tunnel endpoint identifier (TEID) allocated by the target CU;
6) GTP TEID allocated by the IAB-DU;
7) Identity of the target CU;
8) Identity of the IAB-DU (e.g., BAP address);
9) Identity of the UE;
10) An indication of migration type, which can include at least one of the following: partial migration, full migration, DU migration, UE migration, F1 transport migration, and/or F1 switch indication; and/or
11) BH information, which can include at least one of: BAP routing ID, next hop BAP address, and/or egress BH RLC CH ID. The BH information can be used for uplink (UL) mapping or BH RLC channel mapping update/configuration at the IAB node.

The target CU (e.g., of the first network node) may send the UE handover preparation information to the source CU (e.g., of the second network node) via UE associated message (e.g., message specific to, assigned to, or designated for a certain UE 104) and/or non-UE associated XnAP message (e.g., message not specific to a particular UE 104 or message for one or more UEs 104). As a second step, the source CU (e.g., of the second network node) can send/transmit/provide configuration update information to the IAB node (e.g., the third network node or a network node serving the UE 104). The configuration update information can include at least one of the following:
1) IP address of the source CU (e.g., of the second network node) for the control plane or user plane;
2) IP address of the target CU (e.g., of the first network node) for the control plane or user plane;
3) IP address of the IAB-DU (e.g., of the third network node or IAB node) for the control plane or user plane;
4) gNB-CU UE F1AP ID allocated by the source CU;
5) gNB-CU UE F1AP ID allocated by the target CU;
6) gNB-DU UE F1AP ID allocated by the IAB-DU;
7) GTP TEID allocated by the source CU;
8) GTP TEID allocated by the target CU;
9) GTP TEID allocated by the IAB-DU;
10) Identity of the target CU (e.g., sometimes referred to as target CU ID);
11) Identity of the UE (e.g., sometimes referred to as UE ID);
12) BH information, which can include at least one of: BAP routing ID, next hop BAP address, and/or egress BH RLC CH ID; and/or
13) An indication of migration type, which can include at least one of: partial migration, full migration, DU migration, UE migration, F1 transport migration, F1 switch indication, source logical DU indication (e.g., BAP address), target logical DU indication (e.g., BAP address), and/or new IAB donor indication.

The source CU may send the configuration update information to the IAB node via UE associated message and/or non-UE associated F1AP message. As a third step, the IAB node (e.g., the third network node) may send/transmit/provide a response message or signal to the source CU, such as in response to or subsequent to receiving the configuration update information. The response message can include at least one of the following:
1) IP address of the source CU for the control plane or user plane;
2) IP address of the target CU for the control plane or user plane;
3) IP address (e.g., old/previous/existing IP address) of the IAB-DU for the control plane or user plane;
4) New IP address of the IAB-DU for the control plane or user plane;
5) gNB-CU UE F1AP ID allocated by the source CU;
6) gNB-CU UE F1AP ID allocated by the target CU;
7) gNB-DU UE F1AP ID (e.g., old/previous/existing gNB-DU UE F1AP ID) allocated by the IAB-DU;
8) New gNB-DU UE F1AP ID allocated by the IAB-DU;
9) GTP TEID allocated by the source CU;
10) GTP TEID allocated by the target CU;
11) GTP TEID (e.g., old/previous/existing GTP TEID) allocated by the IAB-DU;
12) New GTP TEID allocated by the IAB-DU; and/or
13) Identity of the UE 104 (e.g., UE ID or ID of the wireless communication device).

The IAB node (e.g., the third network node) may send second (e.g., another) configuration update information to the source CU via UE associated message and/or non-UE associated F1AP message. The second configuration update information can include similar, additional, or alternative information compared to the configuration update information received from the source CU. The source CU can receive the second configuration update information from the IAB node.

As a fourth step, the source CU (e.g., of the second network node) may send the second configuration update information to the target CU (e.g., of the first network node). The second configuration update information can include at least one of the following:
1) IP address of the source CU for the control plane or user plane;
2) IP address of the target CU for the control plane or user plane;
3) IP address (e.g., old/previous/existing IP address) of the IAB-DU for the control plane or user plane;
4) New IP address of the IAB-DU for the control plane or user plane;
5) gNB-CU UE F1AP ID allocated by the source CU;
6) gNB-CU UE F1AP ID allocated by the target CU;
7) gNB-DU UE F1AP ID (e.g., old/previous/existing gNB-DU UE F1AP ID) allocated by the IAB-DU;
8) New gNB-DU UE F1AP ID allocated by the IAB-DU;
9) GTP TEID allocated by the source CU;
10) GTP TEID allocated by the target CU;
11) GTP TEID (e.g., old/previous/existing GTP TEID) allocated by the IAB-DU;
12) New GTP TEID allocated by the IAB-DU;
13) Identity of the IAB-DU; and/or
14) Identity of the UE 104 (e.g. UE ID).

Based on the communication of the information (e.g., configuration update information, response message, and/or UE handover preparation information, among others) between the network nodes, the UE's F1 control plane and/or user plane can be migrated/switched/handed over (e.g., undergo handover/migration/switching) to the target donor according to the information.

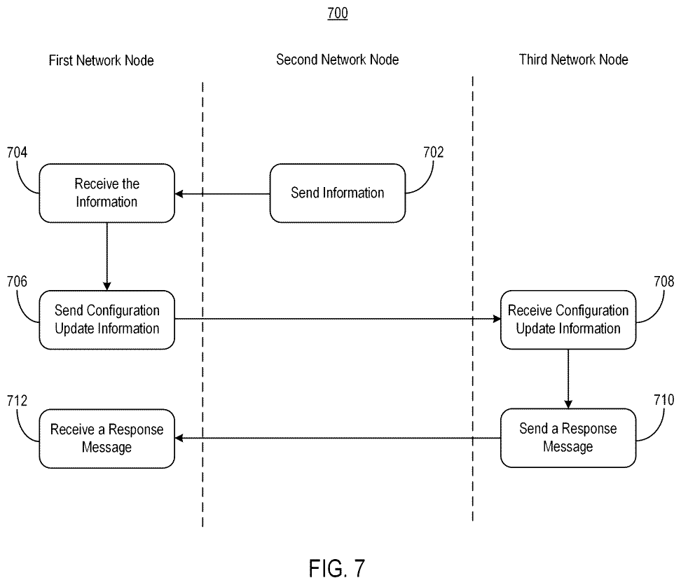

Referring now to FIG. 7, depicted is a flow diagram of a method 700 of inter-donor migration and apparatus. The method 700 may be implemented using or performed by any of the components detailed above, such as the UE 104 or 204 and BS 102 or 202, among others. In overview, a second network node can send/transmit/provide/signal information (702). A first network node can receive/obtain/collect/acquire the information (704). The first network node can send configuration update information (706). A third network node can receive the configuration update information (708). The third network node can send a response message (710). The first network node can receive the response message (712).

In further detail, a second network node (e.g., one of source CU or target CU) can receive send/transmit/provide information related to handover/migration/switching of a wireless communication device (e.g., UE) to a first network node (e.g., one of the other target CU or source CU) (702). In some cases, the first network node can include a target IAB donor (e.g., sometimes referred to as target donor), and the second network node can include a source IAB donor (e.g., sometimes referred to as source donor). In some other cases, the first network node can include the source IAB donor, and the second network node can include the target IAB donor. For instance, in some implementations, the first and second network nodes can include the target and source donors, respectively, while in some other implementations, the first and second network nodes can include the source and target donors, respectively.

In yet other cases, the first network node or the second network node may be an initial CU, such as instead of a source CU or a target CU. Subsequently or after the transmission, the first network node can receive the information from the second network node (704). The first network node may receive the information related to the handover from the second network node via a UE associated message or a non-UE associated message.

In some implementations, the information related to the handover/migration can include at least one of: an IP address of the second network node for control plane or user plane, an IP address of the third network node (e.g., IAB-DU of IAB-node) for control plane or user plane, a gNB centralized unit (gNB-CU) user equipment (UE) F1 application protocol (F1AP) identifier (ID) allocated by the second network node, a gNB distributed unit (gNB-DU) UE F1AP ID allocated by the third network node, a general packet radio service (GPRS) tunneling protocol (GTP) tunnel endpoint identifier (TEID) allocated by the second network node, a GTP TEID allocated by the third network node, an identity of the second network node, an identity (e.g., BAP address) of the third network node, an identity of the wireless communication device, an indication of migration type, and/or backhaul (BH) information. The gNB-CU UE F1AP ID and the gNB-DU UE F1AP ID may be used to identify at least one F1 association (e.g., old UE F1AP ID(s) for the F1 association may be replaced with new UE F1AP ID(s) during UE migration, such that the F1 association for the UE can be migrated from a source donor to a target donor). In various implementations, the information may include other information related to the handover procedure/operation.

In some cases, the first network node may send response information to the second network node. In some other cases, the first network node may not send the response information to the second network node, such as proceed to step (706), among others. The response information can include at least one of: a differentiated service code point (DSCP), an IPv6 flow label, and/or a backhaul adaptation protocol (BAP) control protocol data unit (PDU) radio link control (RLC) channel (CH) list.

Subsequent to receiving the information related to the handover procedure, the first network node can send/transmit/provide configuration update information to a third network node (706). The third network node can include an integrated access and backhaul (IAB) node (e.g., gNB, wireless communication node, or BS). The third network node can receive the configuration update information from the first network node (708). In some implementations, the first network node may transmit the configuration update information to the second network node. The second network node may forward the configuration update information to the third network node. The first network node (or the second network node) can transmit the configuration update information to the third network node via a user equipment (UE) associated message and/or a non-UE associated message.

In some implementations, the configuration update information can include at least one of: an IP address of the first network node for control plane or user plane, an IP address of the second network node for control plane or user plane, an IP address of the third network node (e.g., IAB-DU of IAB-node) for control plane or user plane, a gNB-CU UE F1AP ID allocated by the first network node, a gNB-CU UE F1AP ID allocated by the second network node, a gNB distributed unit (gNB-DU) UE F1AP ID allocated by the third network node (e.g., IAB-DU), a GTP TEID allocated by the first network node, a GTP TEID allocated by the second network node, a GTP TEID allocated by the third network node, an identity of the first network node, an identity of the second network node, an identity of the wireless communication device, an indication of migration type, and/or backhaul (BH) information.

In various aspects, the indication of migration type can include at least one of: partial migration, full migration, DU migration, migration of the wireless communication device (e.g., UE migration/switching/handover), F1 transport migration, F1 switch indication, a source logical DU indication, a target logical DU indication, and/or a new IAB donor indication. In some embodiments/implementations, the BH information can include at least one of: a BAP routing ID, a next hop BAP address, and/or an egress BH RLC CH ID.

Subsequent to receiving the configuration update information, the third network node (e.g., IAB node) can transmit/send a response message to the first network node (or the second network) (e.g., one of the source donor or target donor) that provided the configuration information (710). Accordingly, the first network node can receive the response message from the third network node (712). The first network node can receive/obtain/collect the response message from the third network node via a UE associated message or a non-UE associated message.

In various implementations, the response message can include at least one of: an IP address of the first network node for control plane or user plane, an IP address of the second network node for control plane or user plane, an (e.g., old/previous) IP address of the third network node for control plane or user plane, a new IP address of the third network node for control plane or user plane, a gNB centralized unit (gNB-CU) user equipment (UE) F1 application protocol (F1AP) identifier (ID) allocated by the first network node, a gNB-CU UE F1AP ID allocated by the second network node, a (e.g., old/previous) gNB distributed unit (gNB-DU) UE F1AP ID allocated by the third network node, a new gNB-DU UE F1AP ID allocated by the third network node, a general packet radio service (GPRS) tunneling protocol (GTP) tunnel endpoint identifier (TEID) allocated by the first network node, a GTP TEID allocated by the second network node, a (e.g., old/previous) GTP TEID allocated by the third network node, a new GTP TEID allocated by the third network node, and/or an identity of the wireless communication device.

In some implementations, the first network node (e.g., source donor) may send configuration update information (e.g., second configuration update information) to the second network node (e.g., target donor). This configuration update information may be additional or alternative (e.g., replacement) to the configuration update information sent from the first network node to the third network node. This configuration update information can include at least one of: an IP address of the first network node for control plane or user plane, an IP address of the second network node for control plane or user plane, an IP address of the third network node (e.g., IAB-DU of IAB-node) for control plane or user plane, a new IP address of the third network node for control plane or user plane, a gNB-CU UE F1AP ID allocated by the first network node, a gNB-CU UE F1AP ID allocated by the second network node, a gNB-DU UE F1AP ID allocated by the third network node, a new gNB-DU UE F1AP ID allocated by the third network node, a GTP TEID allocated by the first network node, a GTP TEID allocated by the second network node, a GTP TEID allocated by the third network node, a new GTP TEID allocated by the third network node, an identity of the third network node, and/or an identity of the wireless communication device.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

What is claimed is:

1. A method, comprising:
receiving, by a first network node from a second network node, information related to handover of a wireless communication device; and
sending, by the first network node to a third network node, configuration update information.

2. The method of claim 1, wherein:
the third network node comprises an integrated access and backhaul (IAB) node; and
the first network node comprises a target IAB donor, and the second network node comprises a source IAB donor; or
the first network node comprises the source IAB donor, and the second network node comprises the target IAB donor.

3. The method of claim 1, wherein the information related to the handover comprises at least one of:
an IP address of the second network node for control plane or user plane,
an IP address of the third network node for control plane or user plane,
a gNB centralized unit (gNB-CU) user equipment (UE) F1 application protocol (F1AP) identifier (ID) allocated by the second network node,
a gNB distributed unit (gNB-DU) UE F1AP ID allocated by the third network node,
a general packet radio service (GPRS) tunneling protocol (GTP) tunnel endpoint identifier (TEID) allocated by the second network node,
a GTP TEID allocated by the third network node,
an identity of the second network node,
an identity of the third network node,
an identity of the wireless communication device,
an indication of migration type, or
backhaul (BH) information.

4. The method of claim 1, comprising:
receiving, by the first network node from the second network node, the information related to the handover, via a user equipment (UE) associated message or a non-UE associated message.

5. The method of claim 1, comprising:
sending, by the first network node to the second network node, response information comprising at least one of: a differentiated service code point (DSCP), an IPV6 flow label, or a backhaul adaptation protocol (BAP) control protocol data unit (PDU) radio link control (RLC) channel (CH) list.

6. The method of claim 1, wherein the configuration update information comprises at least one of:
an IP address of the first network node for control plane or user plane,
an IP address of the second network node for control plane or user plane,
an IP address of the third network node for control plane or user plane,
a gNB centralized unit (gNB-CU) user equipment (UE) F1 application protocol (F1AP) identifier (ID) allocated by the first network node,
a gNB-CU UE F1AP ID allocated by the second network node,
a gNB distributed unit (gNB-DU) UE F1AP ID allocated by the third network node,
a general packet radio service (GPRS) tunneling protocol (GTP) tunnel endpoint identifier (TEID) allocated by the first network node,
a GTP TEID allocated by the second network node,
a GTP TEID allocated by the third network node,
an identity of the first network node,
an identity of the second network node,
an identity of the wireless communication device,
an indication of migration type, or
backhaul (BH) information.

7. The method of claim 3, wherein the indication of migration type comprises: partial migration, full migration, distributed unit (DU) migration, migration of the wireless communication device, F1 transport migration, F1 switch indication, a source logical DU indication, a target logical DU indication, or a new integrated access and backhaul (IAB) donor indication.

8. The method of claim 3, wherein the BH information comprises at least one of: a backhaul adaptation protocol (BAP) routing ID, a next hop BAP address, or an egress BH radio link control (RLC) channel (CH) ID.

9. The method of claim 1, comprising:
sending, by the first network node to the third network node, the configuration update information via a user equipment (UE) associated message or a non-UE associated message.

10. The method of claim 1, comprising:
receiving, by the first network node from the third network node, a response message comprising at least one of:
an IP address of the first network node for control plane or user plane,
an IP address of the second network node for control plane or user plane,
an IP address of the third network node for control plane or user plane,
a new IP address of the third network node for control plane or user plane,
a gNB centralized unit (gNB-CU) user equipment (UE) F1 application protocol (F1AP) identifier (ID) allocated by the first network node,
a gNB-CU UE F1AP ID allocated by the second network node,
a gNB distributed unit (gNB-DU) UE F1AP ID allocated by the third network node,
a new gNB-DU UE F1AP ID allocated by the third network node,
a general packet radio service (GPRS) tunneling protocol (GTP) tunnel endpoint identifier (TEID) allocated by the first network node,
a GTP TEID allocated by the second network node,
a GTP TEID allocated by the third network node,
a new GTP TEID allocated by the third network node, or
an identity of the wireless communication device.

11. The method of claim 10, comprising:
receiving, by the first network node from the third network node, the response message via a user equipment (UE) associated message or a non-UE associated message.

12. The method of claim 1, comprising:
sending, by the first network node to the second network node, second configuration update information comprising at least one of:
an IP address of the first network node for control plane or user plane,
an IP address of the second network node for control plane or user plane,
an IP address of the third network node for control plane or user plane,
a new IP address of the third network node for control plane or user plane,
a gNB centralized unit (gNB-CU) user equipment (UE) F1 application protocol (F1AP) identifier (ID) allocated by the first network node,
a gNB-CU UE F1AP ID allocated by the second network node,
a gNB distributed unit (gNB-DU) UE F1AP ID allocated by the third network node,
a new gNB-DU UE F1AP ID allocated by the third network node,
a general packet radio service (GPRS) tunneling protocol (GTP) tunnel endpoint identifier (TEID) allocated by the first network node,
a GTP TEID allocated by the second network node,
a GTP TEID allocated by the third network node,
a new GTP TEID allocated by the third network node,
an identity of the third network node, or
an identity of the wireless communication device.

13. A method, comprising:
sending, by a second network node to a first network node, information related to handover of a wireless communication device,
wherein the first network node sends configuration update information to a third network node.

14. A second network node, comprising:
at least one processor configured to:
send, via a transmitter to a first network node, information related to handover of a wireless communication device,
wherein the first network node sends configuration update information to a third network node.

15. A first network node, comprising:
at least one processor configured to:
receive, via a transceiver from a second network node, information related to handover of a wireless communication device; and
send, via the transceiver to a third network node, configuration update information.

16. The first network node of claim 15, wherein:
the third network node comprises an integrated access and backhaul (IAB) node; and
the first network node comprises a target IAB donor, and the second network node comprises a source IAB donor; or
the first network node comprises the source IAB donor, and the second network node comprises the target IAB donor.

17. The first network node of claim 15, wherein the information related to the handover comprises at least one of:
an IP address of the second network node for control plane or user plane,
an IP address of the third network node for control plane or user plane,
a gNB centralized unit (gNB-CU) user equipment (UE) F1 application protocol (F1AP) identifier (ID) allocated by the second network node,
a gNB distributed unit (gNB-DU) UE F1AP ID allocated by the third network node,
a general packet radio service (GPRS) tunneling protocol (GTP) tunnel endpoint identifier (TEID) allocated by the second network node,
a GTP TEID allocated by the third network node,
an identity of the second network node,
an identity of the third network node,
an identity of the wireless communication device,
an indication of migration type, or
backhaul (BH) information.

18. The first network node of claim 15, wherein the at least one processor is configured to:
receive, via the transceiver from the second network node, the information related to the handover, via a user equipment (UE) associated message or a non-UE associated message.

19. The first network node of claim 15, wherein the at least one processor is configured to:
send, via the transceiver to the second network node, response information comprising at least one of: a differentiated service code point (DSCP), an IPV6 flow label, or a backhaul adaptation protocol (BAP) control protocol data unit (PDU) radio link control (RLC) channel (CH) list.

20. The first network node of claim 15, wherein the configuration update information comprises at least one of:
an IP address of the first network node for control plane or user plane,
an IP address of the second network node for control plane or user plane,
an IP address of the third network node for control plane or user plane,
a gNB centralized unit (gNB-CU) user equipment (UE) F1 application protocol (F1AP) identifier (ID) allocated by the first network node,
a gNB-CU UE F1AP ID allocated by the second network node,
a gNB distributed unit (gNB-DU) UE F1AP ID allocated by the third network node,
a general packet radio service (GPRS) tunneling protocol (GTP) tunnel endpoint identifier (TEID) allocated by the first network node,
a GTP TEID allocated by the second network node,
a GTP TEID allocated by the third network node,
an identity of the first network node,
an identity of the second network node,
an identity of the wireless communication device,
an indication of migration type, or
backhaul (BH) information.
